(19) United States
(12) Patent Application Publication
(10) Pub. No.: US 2022/0329614 A1
(43) Pub. Date: Oct. 13, 2022

(54) METHOD FOR MONITORING COMMUNICATION ON A COMMUNICATION BUS, ELECTRONIC DEVICE FOR CONNECTION TO A COMMUNICATION BUS, AND CENTRAL MONITORING DEVICE FOR CONNECTION TO A COMMUNICATION BUS

(71) Applicant: Volkswagen Aktiengesellschaft, Wolfsburg (DE)

(72) Inventors: Birger Kamp, Rötgesbüttel (DE); Viktor Bunimov, Vechelde (DE); Sascha Forner, Rangsdorf (DE); Roland Hannig, Berlin (DE)

(21) Appl. No.: 17/778,796

(22) PCT Filed: Nov. 10, 2020
(86) PCT No.: PCT/EP2020/081658

§ 371 Date: May 20, 2022

(30) Foreign Application Priority Data
Nov. 22, 2019 (DE) 10 2019 218 045.0

(51) Int. Cl. H04L 9/40; H04L 12/40

(52) U.S. Cl. CPC H04L 63/1425; H04L 12/40; H04L 63/1416; H04L 2012/40215; H04L 2012/40273

(57) ABSTRACT

Technologies and techniques for monitoring a communication bus. A number of electronic stations are networked by the communication bus. During operations, the messages transmitted via the communication bus are identified via an identifier, it being determined for each station which messages each station can send with which identifier. According to a uniqueness rule, it is prohibited for another station to send a payload message with an identifier that is already reserved for this station. In order to expose stations that introduce manipulated messages onto the communication bus, a protocol unit in a station maintains a list of the identifiers of the messages actually sent by the station. The attacker station can be identified via subsequent comparisons with this list.

### RELATED APPLICATIONS

The present application claims priority to International Patent App. No. PCT/EP2020/081658 to Kamp, et al., titled “Method For Monitoring Communication On A Communication Bus, Electronic Device For Connection To A Communication Bus, And Central Monitoring Device For Connection To A Communication Bus”, filed Nov. 10, 2020, which claims priority to German Patent App. No. 10 2019 218 045.0, filed on Nov. 22, 2019, the contents of each being incorporated by reference in their entirety herein.

### TECHNICAL FIELD

The present disclosure relates to the technical field of monitoring communications on a communication bus for unauthorized bus access. The communication bus may be part of a communication bus system used in vehicles. Networked control units are also common in other fields of technology, such as in automation technology, process technology and the like. The present disclosure furthermore relates to an electronic device for connecting to a communication bus.

### BACKGROUND

A multitude of control units are typically installed in modern vehicles. A number of control units are used for the powertrain alone, such as engine control unit, transmission control unit, gear selector lever control unit, airbag control unit and others. In addition, there are further control units that are installed in the region of the vehicle body and ensure certain comfort functions. Examples include the door or window lift mechanism control units, air conditioning control units, seat adjustment control units, and the like. Furthermore, there are control units that are part of the infotainment area, such as camera control unit for monitoring the surroundings, navigation control unit, communication module and entertainment device including TV, radio, video and music functions.

The control units of the different categories are typically in each case networked with a separate bus that is accordingly configured for the device category. As a result, several different bus systems can be used in the vehicle. The different bus systems can be connected to one another via gateways to enable data exchange. In the area of the powertrain control units, and also in the area of the comfort control units, the Controller Area Network (CAN) bus is typically used. Other bus systems are also used in the infotainment area, such as bus systems that are based on Ethernet technology, for example Audio Video Bridging (AVB), which is based on the standard family according to the IEEE.802.1 standard. It is also possible to use bus systems in which data is transmitted via optical waveguides. Examples include the Media Oriented Systems Transport (MOST) bus or the Domestic Digital Bus (D2B) bus.

Bus systems in a motor vehicle area are increasingly becoming the subject of hacker attacks and attempts to deliberately manipulate message contents. Such hacker attacks on the bus system typically occur by way of a connection to the physical transmission medium, that is, the bus line, or by way of access to a so-called on-board diagnostics interface (OBD connector). In addition, cyber security is increasingly gaining attention because ever more complex driver assistance systems find their way into the vehicles, all the way to automated driving. Manipulation in this regard must be precluded.

A need therefore exists to further protect communication on the communication buses in the vehicle as well as elsewhere.

The CAN bus is particularly common in a motor vehicle area and is frequently used for networking security-relevant electronics in the vehicle. As a result, a particular need exists here to protect communication.

An attack detection method for a bus system of a motor vehicle and a corresponding device are known from DE 10 2015 205 670 A1. The key is to detect and avert outside attacks on the bus system. For this purpose, a module is installed in a gateway of the bus system, which employs a general approach for checking as to whether the messages transmitted on the bus were transmitted according to the communication rules. This covers various communication rules: According to one aspect, the module checks certain properties of a fixed message cycle. This includes, for example, the respective time between two consecutive messages, and when the module detects that the time interval between two consecutive messages does not match the predefined cycle duration, it emits a warning. According to another aspect, the module checks whether only identical messages are in each case consecutively transmitted. The checking aspects can relate to a certain message type.

It is known from DE 10 2016 220 895 A1 to take measures in a CAN network by which it is possible to detect manipulation. In the process, a basic CAN controller or a full CAN controller is expanded with an RX filter device, which compares the CAN identifiers intended for transmission to those of the received CAN messages.

A monitoring method for the CAN bus is known from DE 10 2017 216 808 A1. The method takes advantage of the uniqueness rule that exists with a CAN bus, according to which it is prohibited for another station to transmit a user data message with an identifier that has already been reserved for this station. When a violation of the uniqueness rule is determined, an unauthorized bus access was determined.

A method for transmitting a message sequence via a data bus is known from DE 10 2017 218 134 B3. An informational message containing an informational signal is transmitted during an active phase, and a security message for initiating an idle phase as well as idle messages containing an idle signal are transmitted at the interval of an idle cycle time during the idle phase. The informational signal and the idle signal differ from one another, and the security message and the idle messages likewise differ from one another.

### SUMMARY

Aspects of the present disclosure are directed to providing effective monitoring technologies and techniques for operating a communication bus, which are not only able to detect unauthorized bus access, but also offers an opportunity to identify the manipulated stations that emit the introduced messages.

Aspects of the present disclosure are described in the features recited in the independent claims, found below. Further aspects are described in the features recited in the dependent claims.

In some examples, a method is disclosed for monitoring the communication on a communication bus, by which a number of electronic stations are networked. The message format may be configured such that the messages are identified by an identifier, wherein it is established for each station which messages it is allowed to send, and with which identifier. A uniqueness rule may be configured, which prohibits another station from sending a user data message with an identifier that has already been reserved for this station. A list may be maintained by a protocol unit in a control unit, regarding the identifiers of the messages sent by the station, wherein countermeasures are initiated against the identified station when a violation of the uniqueness rule is detected. Maintaining the list in the respective station has the advantage that the monitoring system is designed to be self-learning so that no pre-installation of the lists is required, and the functional scope of the stations can be changed by subsequently enabling functional features, or by a subsequent software update, without having to reprogram lists in the shop. Another advantage is that there is no dependence on the host of the station, and the monitoring method can therefore be designed to be very secure. Additionally, it is an advantage that the option exists to subsequently bring the monitoring system into the station with the aid of a software update.

It may be advantageous in the process when the protocol unit builds the list successively in that a new list entry is generated when the station dispatches a message with an identifier that was not yet previously entered into the list. With this, double entries in the memory are avoided, and storage space can be saved.

In some examples, the list may be sent to a central monitoring station that is connected to the communication bus, along with a message that contains an entry for an identifying piece of information of the sending station, wherein a higher-level monitoring instance that is installed in the central monitoring station carries out a comparison of the identifiers documented in the list to a table in which the pieces of identifying information with respect to the identification of the stations of the communication bus and the reference lists with the identifiers that are assigned to each station and that are permitted to be sent in messages by the station sending the list are documented. This measure allows the station that introduced a fake message to be identified (attacker control unit). This makes the monitoring system considerably more secure since it is then possible to initiate deliberate countermeasures against the identified, manipulated control unit.

In one variant, the message with the logged list may be sent to the central monitoring station, which is connected to the communication bus and has a higher-level monitoring instance, when an end of a working cycle is detected. In the simplest case, a working cycle can be the phase between switching on and switching off the power supply of the communication system.

In another advantageous variant, a detector unit may be installed in a station, which monitors whether a user data message is being sent on the communication bus by another station with an identifier that is documented in the list maintained by the protocol unit, and that a message is sent to the monitoring station, including the higher-level monitoring instance, with the piece of identifying information with respect to the identification of the sending control unit, when the detector unit of the sending station itself detects a violation of the uniqueness rule. In this variant, compliance with the uniqueness rule is checked in the particular station itself. The occurrence of manipulated messages is detected at an earlier stage with this variant. In this example, countermeasures can be initiated at an earlier stage.

In a particularly secure variant, the detector unit may report the detection of a violation of the uniqueness rule to a logic unit in the station, which then generates the message containing the piece of identifying information with respect to the identification of the sending station.

One advantage is that the logic unit can also be configured in such a way that a special security message is received from the station including the installed higher-level monitoring instance, and that the security measure communicated in the security message is initiated by the logic unit.

This monitoring can be used particularly advantageously in the case of a communication bus according to one variant of the family of the CAN bus, corresponding to the Controller Area Network bus. In this regard, triggering the bus-off state for the identified control unit is an obvious countermeasure. In the bus-off state, the station is taken off the communication bus. In the state, the station can then no longer send any take messages. It would also be possible to initiate other countermeasures in this way. The following shall be mentioned as examples of other countermeasures: The initiation of a secure mode, so that the attacker control unit poses no danger. Many control units are equipped with an emergency operating mode in which they only carry out a basic function. Even though it is no longer possible to draw on the full performance of the vehicle with this basic function, for example in the case of a vehicle network, the vehicle can still drive to a repair shop. The CAN bus has been used in vehicles since the early 1990s and is prevalent in this application. The data transmissions that take place via this communication bus are security-relevant, and consequently a high need exists to protect the communication via the CAN bus against manipulation.

Examples of further countermeasures that can be used in aspects of the present disclosure include, but are not limited to:
outputting a warning to the vehicle driver, for example by way of an optical, an acoustic or a haptic signal;
turning on the alarm system;
outputting a manipulation notification via radio to a database central computer of the vehicle manufacturer or an authority or to a smart phone of the vehicle owner;
storing location, date, time of the manipulation event in a memory;
blocking the key which was used to turn on the vehicle.

The enumeration is not exhaustive, and it is also possible to employ several of the listed countermeasures simultaneously.

The method may be tailored for use in a CAN bus in that the identifier that is logged corresponds to a CAN bus message identifier.

The monitored user data messages can correspond to a so-called CAN bus standard data frame.

In the event that a CAN bus remote frame message containing a message identifier that is reserved for the station is detected, the detector unit does not assume that an unauthorized bus access has occurred, and that no message containing a piece of identifying information with respect to the identification of the sending control unit is sent to the station including the higher-level monitoring instance, in some examples. In other examples, a remote frame can regularly use the same message identifier. This message, however, does not contain any user data, and is consequently not considered to be quite as dangerous.

In some examples, an electronic device is disclosed for connecting to a communication bus and is characterized in that the device comprises a protocol unit, which is configured to maintain a list regarding the identifiers of the messages sent by the electronic device, wherein a sent message in each case is identified by an identifier, wherein it is established for each electronic device which messages it is allowed to send, and with which identifier, and wherein a uniqueness rule applies, which prohibits another station from sending a user data message with an identifier that has already been reserved for another electronic device. This yields the same advantages as for the method discussed herein.

In some examples, the electronic device may include a logic unit, which sends the list that is maintained by the protocol unit to a central monitoring station, which is connected to the communication bus and includes a higher-level monitoring instance, along with a message that contains an entry for a piece of identifying information of the sending electronic device. With this measure, the corresponding method is implemented in an electronic device.

The logic unit of the electronic device can be configured to receive a special security message from the station including the installed higher-level monitoring instance, and to initiate a countermeasure that is communicated in the security message.

In some examples, the electronic device may include a detector unit, which is configured to monitor whether a user data message is being sent on the communication bus from another station with an identifier that is documented in the list that is maintained by the protocol unit, and that the logic unit is configured to send a message to the central monitoring station, including the higher-level monitoring instance, containing a piece of identifying information with respect to the identification of the sending electronic device, when the detector unit of the sending device itself detects a violation of the uniqueness rule. As mentioned for the corresponding method, this has the advantage that the fake messages can be detected at an earlier stage.

In the case of the CAN bus, the user data message would correspond to a CAN bus standard data frame.

For a central monitoring device for connecting to a communication bus, it may be advantageous that the device contains a directory with the bus stations that are connected to the communication bus, including the respective pieces of identifying information thereof and the respective reference lists thereof, wherein the message identifiers which are established for each bus station and which the respective bus station is allowed to send are listed in the reference lists. A uniqueness rule applies, which prohibits another bus station from sending a user data message containing an identifier that has already been reserved for another bus station. To expose an attacker station, the monitoring device includes a monitoring instance, which is configured to carry out a comparison between the reference lists and a suspicious message identifier reported in a message, or to carry out a comparison between the reference lists and the reported logged lists. When a logged list includes a message identifier that, however, is not documented in the associated reference list, this bus station is exposed as having been manipulated. Likewise, a bus station is exposed when the reported suspicious message identifier is not documented in the associated reference list.

To carry out countermeasures against the exposed bus station, it is advantageous when the central monitoring device comprises a transmitter unit, which sends a security message containing a security measure to the bus station whose piece of identifying information matches the reported piece of identifying information for a received logged list, for which the associated reference list does not contain an entry for the message identifier that is logged in its list, or whose piece of identifying information matches the reported piece of identifying information in a message with which a suspicious message identifier was reported, for which the associated reference list does not contain an entry for the reported suspicious message identifier.

### BRIEF DESCRIPTION OF THE DRAWINGS

The drawings show an exemplary embodiment of the invention, which will be described in more detail hereafter based on the figures.

In the drawings:

FIG. 1 illustrates networking electronic components of a CAN bus system according to some aspects of the present disclosure;

FIG. 2 shows a block diagram for a vehicle communication network including control units of different categories, according to some aspects of the present disclosure;

FIG. 3 shows a format for a standard frame transmission frame for the CAN bus, according to some aspects of the present disclosure;

FIG. 4 shows a format for a remote frame transmission frame for the CAN bus, according to some aspects of the present disclosure;

FIG. 5 shows a block diagram of a CAN bus interface, which is equipped with a monitoring module according to some aspects of the present disclosure;

FIG. 6 shows a flow chart for a program that is installed as a monitoring module on the CAN bus interface, according to some aspects of the present disclosure; and

FIG. 7 shows a flow chart of a first variant of an attack detection, according to some aspects of the present disclosure.

### DETAILED DESCRIPTION

The present description illustrates various aspects of the present disclosure. It shall therefore be understood that those skilled in the art will be able to design various arrangements that are not explicitly described here, but that embody principles of the disclosure and the scope of which shall likewise be protected.

The CAN bus was first standardized in 1994. The corresponding ISO standard has the number ISO 11898. A standard exists for the high-speed range up to 1 Mbit/s, which is the ISO 11898-2 standard. And a standard exists for the low-speed range up to 125 kbit/s, which is the ISO 11898-3 standard. Ever growing volumes of data result in ever higher bus loads on the CAN buses. This prompted the further development of the CAN bus. The extended CAN bus is known by the term CAN FD bus. FD denotes flexible data rate. In this CAN bus variant, different data rates are selected. The rate remains low for the arbitration phase, as in the classical CAN bus. For the transmission of user data, the transmission is switched to a higher data rate. If the user data in a CAN-FD message is transmitted faster, the period during which the bus is occupied is reduced; and the load on the bus is reduced. If the transmission duration remains in the same time frame as in classical CAN messages, larger amounts of data could be transported with a CAN-FD message. This method was also implemented in CAN FD. Instead of the 8-byte long user data field, a user data field up to 64 bytes long is used in CAN FD. In one implementation, the data rate for the transmission of the user data field increases, for example, from 500 kbit/s to 2 Mbit/s.

There is also a special CAN remote frame format in the classical CAN bus. The CAN remote frame is sent by one station to request certain data from another station.

As used herein, bus stations may be referred to as control units, as is customary in the automotive field. However, it is also possible for a bus station not to be designated as a control unit. Certain sensors or actuators (such as final control elements) that are connected to the bus are mentioned as examples.

FIG. 1 illustrates networking electronic components of a CAN bus system. A CAN network may be configured as an integrated system, made up of a CAN interface (electronic components, such as control units, sensors, actuators), which exchange data with one another via their respective CAN interfaces and a transmission medium (CAN bus) connecting all CAN interfaces. Three CAN nodes 10 are shown. The bus structure of the CAN bus is linear. Therefore, there is one bus line 15 to which all three CAN nodes 10 are connected. A twisted, unshielded two-wire cable (unshielded twisted pair, UTP) is used as the bus line 15 in the most common cases, over which symmetrical signal transmission takes place. In the symmetrical signal transmission, the signals are transmitted as voltage differences via two lines. The line pair is composed of a non-inverted CANH and an inverted signal line CANL. From the difference between the signals present on these two wires, the receivers reconstruct the original data signal. This has the advantage that common-mode interferences that occur on both wires of the bus line 15 are cancelled out by the difference formation and thus do not affect the transmission.

To avoid signal reflections, the bus line 15 is terminated at both ends of the cable with a terminating resistor 13 of the same size as the characteristic impedance of the bus line (120 ohms).

A CAN interface is composed of two parts: the communication software and the communication hardware. While the communication software encompasses higher communication services, the basic communication functions are typically implemented as hardware. Here, two hardware components are distinguished: The CAN controller 14 ensures the uniform implementation of the CAN communication protocol, thereby relieving the host 16 on which the aforementioned communication software is running. The CAN transceiver 12 is responsible for coupling the CAN controller 14 to the CAN bus 15. It shapes the signals for data transmission during the transmission process and performs the signal processing in the receiver case.

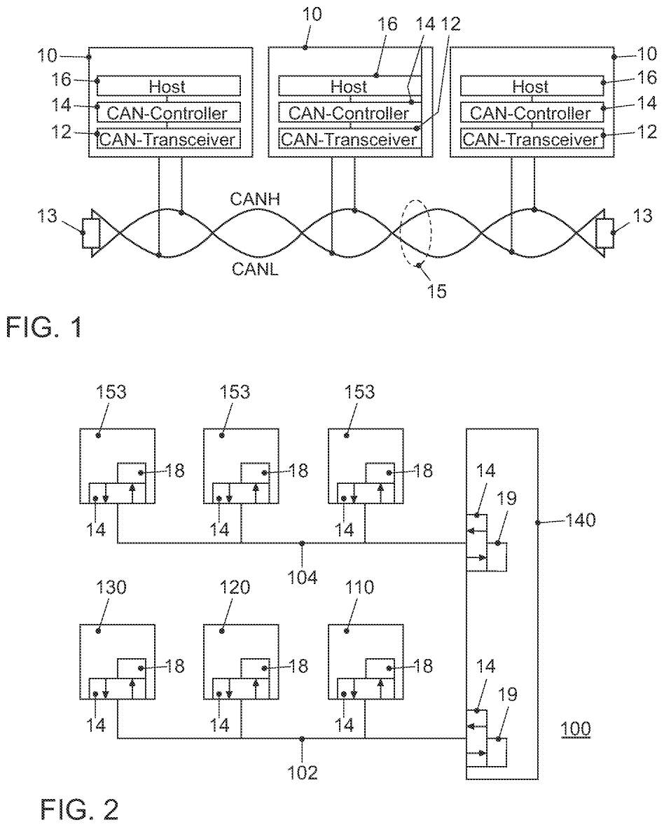

FIG. 2 shows the typical design of a communication network of a modern motor vehicle. Reference numeral 151 denotes an engine control unit. Reference numeral 152 corresponds to a selector lever control unit, and reference numeral 153 denotes a transmission control unit. Additional control units, such as an additional driving dynamics control unit (for vehicles comprising electrically adjustable dampers), an airbag control unit, and the like, can be present in the motor vehicle. Such control devices, all of which are considered to be part of the powertrain category, are typically networked with the CAN bus system (Controller Area Network) 104, which is standardized as an ISO standard, usually as ISO 11898-1. For different sensors in the motor vehicle that are no longer only connected to individual control units, it is likewise provided to connect these to the bus system 104, and for the sensor data thereof to be transmitted to the individual control units via the bus. Examples of sensors in the motor vehicle are wheel speed sensors, steering angle sensors, acceleration sensors, rotation rate sensors, tire pressure sensors, distance sensors, knock sensors, air quality sensors, and the like. Using the selector lever operating device, which is connected to the selector lever control unit, the driver can select driving modes. These include gear selection and engine settings such as sports mode, normal mode, all-wheel drive, and the like.

The modern motor vehicle can comprise additional components, however, such as video cameras, for example in the form of a back-up camera or a driver monitoring camera. The motor vehicle also contains other electronic devices. These are more likely arranged in the area of the passenger compartment, and are often also operated by the driver. Examples include a user interface device, by which the driver can implement settings, but also operate classical components. These include the turn signal control, windshield wiper control, light control, audio settings for the radio, other settings for the car phone, navigation system, and the like. This user interface arrangement is denoted by reference numeral 130. The user interface arrangement 130 is often also equipped with a rotary/pressure switch, by way of which the driver can select the different menus displayed on a display in the cockpit. On the other hand, this category also covers a touch-sensitive display. Even voice input for assisting with the operation falls under this area.

The navigation system has the reference numeral 120, which is likewise installed in the area of the cockpit, in this example. The route, which is indicated on a map, may also be displayed on the display in the cockpit. Additional components, such as a hands-free car kit, can be present, but are not shown in greater detail. Reference numeral 110 denotes an on-board unit. This on-board unit 110 corresponds to a communication module via which the vehicle can receive and send mobile data. Typically, this is a wireless communication module, for example, according to the LTE standard. All these devices are to be considered part of the infotainment area. They are therefore networked by way of a bus system 102 configured to meet the specific needs of this device category. In the example shown, it is assumed that the bus system 102 was also implemented in one variant of the CAN bus. The aforementioned CAN FD bus would be a possibility, since data can be transported at a higher data rate there, which is advantageous for the networked control units in the infotainment area.

Often times, another bus system is used for the infotainment area. In this regard, reference is made to the AVB (Audio Video Bridging) bus systems, the MOST (Media Oriented Systems Transport) bus or the D2B (Domestic Digital Bus) as an example. For the purpose of transmitting vehicle-relevant sensor data via the communication interface 110 to another vehicle or to an external central computer of a database, the gateway 140 is provided. This is connected to the two different bus systems 102 and 104. The gateway 140 is configured to convert the data it receives via the CAN bus 104 in such a way that the data is converted into the transmission format of the infotainment bus 102, so that it can be distributed in the packets specified there. For forwarding this data to the outside, that is, to another motor vehicle or to a central computer, the on-board unit 110 is equipped with the communication interface to receive these data packets and, in turn, convert them into the transmission format of the corresponding mobile communication standard that is used. A conversion is likewise necessary when the bus 102 is implemented as a CAN FD bus.

As is shown in FIG. 2, a monitoring module 18 is provided at each of the control units connected to the respective CAN bus 102, 104.

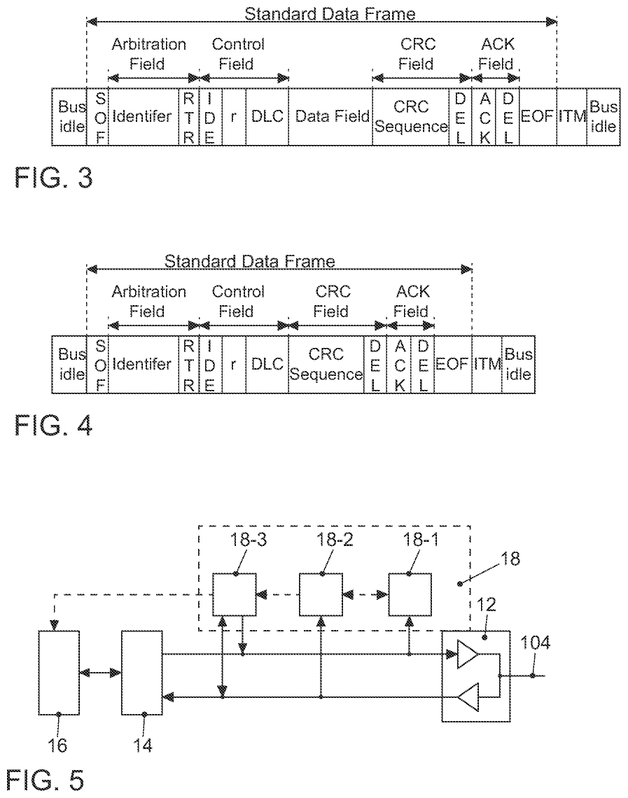

FIG. 3 shows the message format of a CAN standard frame. More precisely, FIG. 3 illustrates a CAN transmission frame format according to the CAN communication standard.

There are many different individual bits in the transmission frame in accordance with ISO 11898-1, which fulfill control functions. The different fields and control bits of the transmission frame are listed with their names in English in the following table. Likewise, the lengths of the individual fields are provided. In subsequent mentions of these bits, the full name will not be repeated.

| Control Bit | Detailed Description | Length | |
|---|---|---|---|
| SOF | Start of Frame | 1 | Bit |
| Identifier | Identifier | 9 | Bits |
| RTR | Remote Transmission Request | 1 | Bit |
| IDE | Identifier Extension | 1 | Bit |
| r | Reserved Bit | 1 | Bit |
| DLC | Data Length Code | 4 | Bits |
| Data Field | Data Field | 0-8 | Bytes |
| CRC | CRC Sequence | | |
| DEL | CRC Delimiter | 1 | Bit |
| ACK | Acknowledge | 1 | Bit |
| DEL | ACK Delimiter | 1 | Bit |
| EOF | End of Frame Code | 4 | Bits |

A CAN frame includes a Start of Frame (SOF) Field, an Arbitration Field, a Control Field, a Data Field, a Cyclic Redundancy Check (CRC) Field, an ACK Field, an End of Frame (EOF) Field, and an Intermission Sequence (ITM) Field.

In some examples, the SOF Field may be a field that indicates the start of a CAN frame, that is, the start of a message. The Arbitration Field identifies a message and assigns a priority to the message. According to the length of an identification field assigned to the Arbitration Field, the CAN frame is divided into a standard format and an extended format (the standard format is shown). In the standard format, the Arbitration Field has a length of 11 bits. For the extended format, the length of the identification field in the Arbitration Field is 29 bits.

The identifier establishes the priority of the data frame and, together with acceptance filtering, ensures the sender-receiver relations in the CAN network which are defined in the communication matrix. In the communication matrix, it is established for each control unit which messages the control unit processes. As a result, when a message arrives whose message identifier is not listed there, this message is sorted out by acceptance filtering, and is not forwarded to the application.

By means of the RTR bit, the sending station communicates the frame type (data frame or remote frame) to the receivers. A dominant RTR bit indicates a data frame, and a recessive bit accordingly indicates the remote frame. The Arbitration Field can additionally contain an Identifier Extension (IDE) Field having a length of 1 bit, so as to identify whether a frame has the standard format or the extended format. When the value of the IDE field is 0, this indicates the standard format. When the value is 1, this means the extended format.

In the DLC field, the number of user data bytes contained in the message are displayed to the receivers. The user data bytes are transported in the Data Field. A maximum of eight user data bytes can be transmitted with a data frame, or up to 64 bytes in the case of CAN FD. The user data bytes are protected against transmission errors by means of a checksum that is transmitted in the CRC Field, using the cyclic redundancy check.

Proceeding from the result of the CRC check, the receivers positively or negatively acknowledge receipt in the ACK slot. An ACK bit is transmitted at the end of the message by the CAN controllers which exactly received the message. The node that sent the message checks whether or not the ACK bit is present on the CAN bus. If ACK is not found, this is an indication that a node was not able to correctly receive the message, and the sending station can attempt another transmission.

The transmission of a data frame is ended with seven recessive bits, which corresponds to the End-of-Frame code EOF.

FIG. 4 shows the message format of a CAN remote frame. A control unit can request desired user data with the remote frame unless the data is sent cyclically anyhow. This frame type is rarely used in automobile applications since the data transmission there does not take place based on demand, but essentially cyclically.

Except for the missing Data Field, the design of the remote frame corresponds to that of the data frame. The distinction between data and remote frame is made by means of the RTR bit. In the case of a data frame, the RTR bit is sent as dominant. A remote frame is identified by a recessive RTR bit.

In principle, corresponding remote frames can be defined in the CAN network for all existing data frames. It is only necessary to ensure that the identifiers of the remote frames match the identifiers of the associated data frames. As soon as a CAN node receives a remote frame whose identifier is identical to an identifier in the own communication matrix, the node responds with the corresponding standard frame.

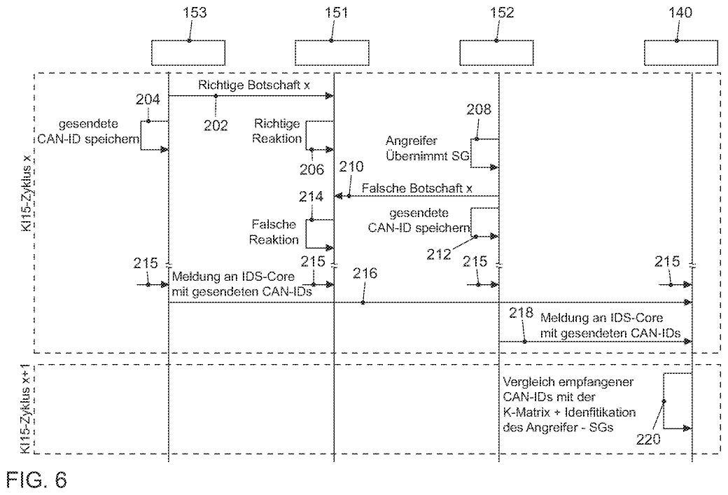

FIG. 5 shows an example of the monitoring module 18 in the form of a software module in a control unit. The CAN interface of the control unit may include the following components: a CAN transceiver 12 and a CAN controller 14. Reference numeral 16, in turn, denotes the host hardware and software of the control unit. The monitoring module 18 is implemented with the aid of software and is composed of the following three components: a protocol unit 18-1, a detector unit 18-2, and a logic unit 18-3.

Two different variants are described hereafter, by way of which an attack detection can be caned out for the on-board electronic system 100 of the example shown in FIG. 2. The variant according to FIG. 6 corresponds to a cyclical attack detection. In the example shown, the cycle time is coupled to the operating phase of the vehicle. In the case of vehicles, the operating phase relates to a so-called terminal 15 cycle. This designation traditionally stems from the beginnings of motor vehicle engineering. Terminal 15 traditionally denotes the switched positive pole of the battery. By turning the ignition key, this switching process took place. Modern vehicles frequently have a start button, which likewise switches on the power supply. However, some devices remain connected to the power supply even though the normal mode has been ended by renewed pushing of the start button. Such devices then switch, for example, from normal mode into stand-by mode in which these consume less power, but still perform tasks. A car body control unit shall be mentioned as an example, which in stand-by mode awaits a wireless signal from a keyless entry system so as to then unlock the doors when the wireless signal arrives.

FIG. 6, from top to bottom, shows two consecutive terminal 15 cycles. Various message transmissions between the control units in the powertrain are shown for the T15 cycle x. At the top, the following control units are shown from left to right: transmission control unit 153, engine control unit 151, manipulated selector lever control unit 152, and gateway 140. First, a message is transmitted in step 202 via the CAN bus 104 from the transmission control unit 153 to the engine control unit 151. This is a regular message, which is sent in the format of the standard data frame, as is shown in FIG. 3. This message is accepted by the engine control unit 151 since it was recognized as relevant for the engine control unit 151 as a result of the acceptance filtering process. The corresponding correct reaction to receiving this message takes place in step 206 on the part of the engine control unit 151. If important measuring data is involved, the data can be stored in the memory, and the control program running in the host 16 accesses the data to execute a control function, which is to take place taking this measuring data into consideration. At the same time, an entry is made on the part of the protocol unit 18-1 of the CAN interface in a list regarding the station's own CAN identifier. This takes place in step 204. This list is incrementally completed, as more messages are sent from the transmission control unit 153. This list is intended to subsequently expose an attacker control unit. However, to do so, the attacker control unit also has to build a list.

In a variant that is better protected against manipulation, each control unit, including the attacker control unit, must be equipped with an appropriately configured hardware building block, which comprises this protocol unit. A corresponding implementation in a hardware block can be used for this purpose, which is integrated in the CAN transceiver or the CAN controller. In the example shown, the attacker control unit is a manipulated selector lever control unit 152. In step 208, the attacker control unit is given the command to send a fake message onto the CAN bus 104. This can also be triggered by a manipulated control program, for which detailed knowledge about the default control program would be required. In step 210, the attacker control unit 152 sends the fake message onto the CAN bus 104. The engine control unit 151 accepts the fake message because the message passes its acceptance filtering. In step 214, a wrong reacting occurs on the part of the engine control unit 151. This can be caused by the control program using the fake transmitted measured value or parameter value. Subsequently, further regular and fake messages can also be transmitted via the CAN bus 104, which are not described in greater detail. Finally, a terminal 15 event takes place in step 215.

With this, the on-board electronic system 100 is switched off. However, no immediate shut-off takes place. The control units are “shut down” in a controlled manner, while still completing some tasks in the process, such as storing set parameters or resetting certain set parameters, and the like. The subsequent steps 216 and 218 correspond to steps that take place in connection with the shut-down of the control units 153 and 152. In step 216, the transmission control unit 153 reports its logged list of the CAN identifiers it has sent in messages to a higher-level monitoring instance. This monitoring instance is preferably accommodated in a central network node. The gateway 140 is an obvious choice in the case of the on-board electronic system 100 of vehicles. The message containing the list of CAN identifiers that are used is sent via the CAN bus 104 to the gateway 140. Since the user data field in the standard data frame is limited, multiple CAN messages have to be transmitted.

Each of these messages transmitting a portion of the logged CAN identifiers also contains a piece of identifying information of the sending control unit. In one variant, this piece of identifying information can indicate the type of the control unit. In the case of the transmission control unit 153, the information that the message transmits the CAN identifiers of a transmission control unit is entered as the piece of identifying information. The same notification is also sent from the attacker control unit 152 to the gateway 140. The attacker control unit 152 also supplies all logged CAN identifiers to the gateway 140. Since the attacker control unit 152 also logs the CAN identifiers of the fake messages, these are also supplied to the higher-level monitoring instance in the gateway 140. This is also what the capability of exposing the attacker control unit 140 is based on. In the shown example, however, the process of exposing the attacker control unit 140 only takes place in the subsequent terminal 15 cycle, that is, during the next starting process of the on-board electronic system 100.

In FIG. 6, the subsequent terminal 15 cycle is denoted by the index x+1. The transmitted CAN identifier protocols are evaluated in step 220. In step 220, a received CAN identifier protocol is compared to a reference list archived in the monitoring instance. The reference list contains the regular CAN identifiers assigned to the associated control unit. This list is stored in each control unit and is used for the purpose of acceptance filtering when a CAN message is received, so as to decide whether the message is relevant for the own control unit or is directed at another control unit. The reference list is also at times referred to as a K-matrix, that is communication matrix. It should be ensured that all reference lists of the control unit combination in the on-board electronic system 100 are present in the monitoring instance of the gateway 140. These reference lists can be programmed into the gateway 140 in a protected memory area (for example, EPROM) at the end of production during the manufacture of the vehicle. When testing the list that is logged by the protocol unit 18-1 in the selector lever control unit 152, it is then detected that the CAN identifier of the fake message sent in step 210 was additionally logged. This CAN identifier is not documented in the reference list. In this way, it is detected that the selector lever control unit 152 has been manipulated.

Thereafter, one or more of the described countermeasures are initiated by the monitoring instance. This takes place in such a way that a message is sent via the CAN bus 104 to the attacker control unit 152 from the monitoring instance in the gateway. The logic unit 18-3 is provided for this purpose in each control unit. The logic unit 18-3 in the selector lever control unit 152 receives the message containing the security measure from the gateway 140. The logic unit can be connected to the host 16 by a direct signal line and send a command to shut off or turn on a secure mode to the host. As an alternative, it would be possible to supply this command to the CAN controller 14 by way of a CAN message. Another security measure is to trigger a bus-off state on the part of the logic unit. With this, the connection to the CAN bus 104 is interrupted.

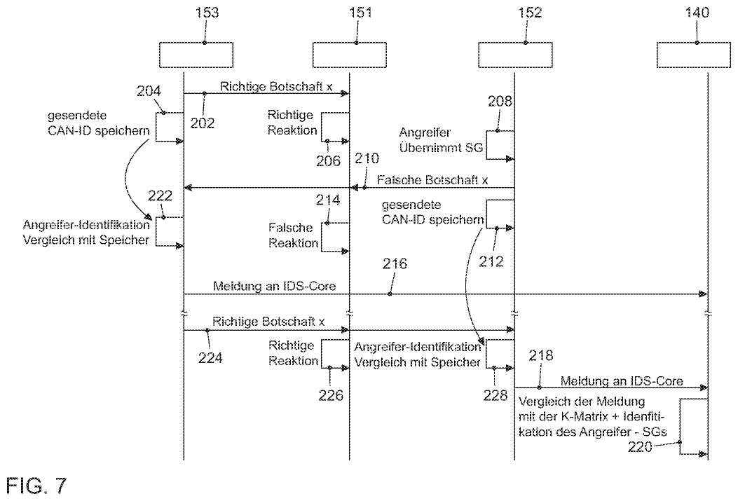

FIG. 7 shows another variant of the attack detection. Identical reference numerals denote the same components, as described above. The difference is that, with this, immediate attack detection is achieved. This requires that the control units themselves carry out a comparison to the list created by the protocol unit 18-1. This is also carried out when the list is still incomplete. The comparison to the logged list is carried out in the detector unit 18-2. With each incoming message, a comparison between the CAN identifier that is contained in the message and the logged list is carried out. This comparison takes place for the first time in the transmission control unit 153 in step 222, after the fake message was sent from the attacker control unit 152 in step 210.

The result of the comparison is a match with the entry in the list that was logged in the transmission control unit 153. Whenever a match has been detected, this means, due to the existing uniqueness rule, that a potential attack was detected. In step 216, this is then immediately reported to the monitoring instance in the gateway 140. The piece of identifying information for the reporting control unit is, in turn, entered into this notification, as is the CAN identifier of the received message for which the match was detected. However, the monitoring instance is still not able to identify the attacker control unit with this. This question is not clarified until the control unit that has integrity sends another regular message containing the suspicious CAN identifier. This takes place in step 224 by the transmission control unit 153.

In step 228, it is then detected in the selector lever control unit 152 that an identical CAN identifier has been received, which is also documented in the list that is maintained by the station's own protocol unit 18-1. As a result, a notification is also provided in step 218 to the monitoring instance in the gateway 140, which provides information about the suspicious CAN identifier and the piece of control unit-identifying information of the selector lever control unit 152. Thereafter, two notifications are present in the monitoring instance, one from the regular control unit and one from the attacker control unit 152. This information is sufficient to identify the attacker control unit 152. For this purpose, a comparison is carried out in the monitoring instance in step 220 between the reference lists present there and the suspicious CAN identifier. There will be a regular reference lists, in which the CAN identifier is documented.

When this reference list was found, the monitoring instance is able to ascertain which piece of control unit-identifying information matches this reference list. The notification containing this piece of control unit-identifying information then stemmed from the control unit that has integrity. However, with this, the attacker control unit is exposed at the same time. It is the control unit from which the other notification stems. Thereafter, again one or more countermeasures are initiated against the identified attacker control unit. As an alternative, an assignment list could also be stored in the monitoring instance, in which the regular pieces of control unit-identifying information are documented for the individual CAN identifiers. The complex search for the matching reference list would then be dispensed with.

It shall also be noted that an attack could already be inferred from the number of stored entries in the list that is maintained by the protocol unit.

It shall also be noted that the lists that are maintained by the protocol unit should be protected against a memory overflow, so as to be able to cope with an attack that involves flooding the CAN bus with a large number of different CAN IDs.

The disclosure is not limited to the exemplary embodiments described here. There is room for various adaptations and modifications, which a person skilled in the art would consider to be part of the disclosure based on his or her knowledge in the art.

Various variants exist for implementing the described solution for the attacker identification:
1. Software solution in which the protocol unit, detector unit and logic unit modules are installed as part of the interface software in the control unit.
2. Software solution that is installed in an additional hardware security module.
3. Hardware solution that is integrated into the CAN transceiver chip or CAN controller chip.

Of these implementation variants, the last two implementation types can be classified as being relatively secure from manipulation.

The described monitoring method could also be used with bus systems other than the CAN bus. In particular, the Local Interconnect (LIN) bus shall be mentioned as an example. The LIN bus, however, is a master/slave bus, in which an identifier is likewise provided in the message format, but which can also identify a certain control command.

All examples mentioned herein as well as conditional formulations shall be understood as not being limited to the specially cited examples. It is recognized by those skilled in the art, for example, that the block diagram shown here represents a conceptual view of an exemplary circuit arrangement. Similarly, it is apparent that an illustrated flow chart, state transition diagram, pseudo code and the like represent different variants to represent processes that can essentially be stored in computer-readable media, and can thus be carried out by a computer or processor.

It shall be understood that the provided method and the associated devices can be implemented in various forms of hardware, software, firmware, special processors or a combination thereof. Special processors can be application-specific integrated circuits (ASICs), reduced instruction set computers (RISCs) and/or field programmable gate arrays (FPGAs). The provided method and the device are preferably implemented as a combination of hardware and software. The software is preferably installed as an application program on a program memory device. This is typically a computer platform-based machine that comprises hardware, such as, for example, one or more central units (CPU), a direct access memory (RAM), and one or more input/output (I/O) interfaces. Typically, an operating system is additionally installed on the computer platform. The various processes and functions that were described here can be part of the application program or a part that is executed by way of the operating system.

### LIST OF REFERENCE SIGNS

10 CAN node
12 CAN transceiver
13 terminating resistor
14 CAN controller
15 bus line
16 host
18 monitoring module
18-1 protocol unit
18-2 detector unit
18-3 logic unit
19 monitoring instance
100 motor vehicle electronic system
102 infotainment CAN bus
104 CAN bus
110 on-board unit
120 navigation system
130 operating unit
140 gateway
151 engine control unit
152 selector lever control unit
153 transmission control unit
202-228 various steps of a method for attack detection

1-15. (canceled)

16. A method for communicating on a communication bus networking a plurality of electronic stations, comprising:
transmitting messages transmitted via the communication bus, each of the messages comprising an identifier establishing for each electronic station which messages it is allowed to send;
storing, in a protocol unit of each of the respective plurality of electronic stations, a list of identifiers for each transmitted message; and
applying a uniqueness rule to the messages, prohibiting another station from sending a user data message containing an identifier that has already been reserved for a respective station.

17. The method according to claim 16, further comprising building each list successively, via the protocol units, such that a new list entry is generated when the respective station sends a message containing an identifier that was not yet previously entered into the list.

18. The method according to claim 16, further comprising
transmitting each list to a central monitoring station via the communication bus, wherein transmitting each list comprises transmitting a message comprising an entry for identifying a portion of information of the transmitting station;
comparing, via a higher-level monitoring instance in the central monitoring station, the identifiers in the list to a reference list to determine one or more stations permitted to send messages.

19. The method according to claim 18, further comprising detecting an end of a working cycle after the comparing.

20. The method according to claim 18, further comprising
detecting, via a detector unit, a violation of the uniqueness rule by monitoring a user data message transmitted by another station with an identifier that is stored in a respective list of a respective protocol unit, and
transmitting a message to a central monitoring station, the message comprising a portion of identifying information with respect to the monitored station.

21. The method according to claim 16, further comprising reporting, via the detector unit, the detection of the violation of the uniqueness rule to a logic unit, wherein the transmitted message is generated by a logic unit.

22. The method according to claim 21, further comprising receiving, in the logic unit, a security message comprising a higher-level monitoring instance, and initiating a countermeasure in accordance with the security message.

23. The method according to claim 16, wherein the communication bus comprises a Controller Area Network (CAN) bus, and further comprising triggering a bus-off state if the uniqueness rule is violated.

24. The method according to claim 23, further comprising detecting a CAN bus remote frame message comprising a message identifier that is reserved for a respective electronic station.

25. An electronic device for communicating on a communication bus, networking a plurality of electronic stations, comprising:
communications for transmitting messages, each of the messages comprising an identifier establishing for each electronic station which messages it is allowed to send; and
a protocol unit for storing a list of identifiers for each transmitted message, wherein the protocol unit is configured to apply a uniqueness rule to the messages, prohibiting another station from sending a user data message containing an identifier that has already been reserved for a respective station.

26. The electronic device according to claim 25, wherein the protocol unit is configured to build each list successively such that a new list entry is generated when the respective station sends a message containing an identifier that was not yet previously entered into the list.

27. The electronic device according to claim 25, wherein the protocol unit is configured to transmit each list to a central monitoring station via the communications by transmitting a message comprising an entry for identifying a portion of information of the transmitting station, and further comprising
a central monitoring station, for comparing, via a higher-level monitoring instance, the identifiers in the list to a reference list to determine one or more stations permitted to send messages.

28. The electronic device according to claim 27, wherein the central monitoring station is configured to detect an end of a working cycle after the comparing.

29. The electronic device according to claim 27, further comprising a detector unit for detecting a violation of the uniqueness rule by monitoring a user data message transmitted by another station with an identifier that is stored in a respective list of a respective protocol unit, and transmitting a message to a central monitoring station, the message comprising a portion of identifying information with respect to the monitored station.

30. The electronic device according to claim 25, further comprising a detector unit for reporting the detection of the violation of the uniqueness rule.

31. The electronic device according to claim 30, wherein the logic unit is configured to receive, a security message comprising a higher-level monitoring instance, and initiate a countermeasure in accordance with the security message.

32. The electronic device according to claim 25, wherein the communications comprises a Controller Area Network (CAN) bus, and further comprising triggering a bus-off state if the uniqueness rule is violated.

33. The electronic device according to claim 32, wherein the protocol unit is configured to detect a CAN bus remote frame message comprising a message identifier that is reserved for a respective electronic station.

34. A central monitoring device for a communication bus comprising
a memory for storing a directory of bus stations communicating with the communication bus, the directory comprising respective portions of identifying information of the bus stations, and a respective reference lists thereof, each reference list comprising message identifiers establishing each bus station allowed to send messages on the communication bus; and
a processing apparatus comprising a monitoring device, operatively coupled to the memory, the processing apparatus configured to apply a uniqueness rule to prohibit another station from sending a data message comprising an identifier that has been reserved for another bus station, wherein the monitoring device comprises a monitoring instance configured to compare the reference lists and a message identifier identified as suspicious and reported in a message, to prohibit transmission of the reported message.

35. A central monitoring device of claim 34, wherein the processing apparatus comprises a transmitter unit, for sending a security message comprising a security measure to a bus station, whose portion of identifying information matches the reported message, in which the associated reference list does not include an entry for a message identifier that is logged, or whose portion of identifying information matches the reported portion of identifying information in a message with which a suspicious message identifier was reported, in which the associated reference list does not include an entry for the reported suspicious message identifier.
